(19) United States
(12) Patent Application Publication
(10) Pub. No.: US 2023/0420971 A1
(43) Pub. Date: Dec. 28, 2023

(54) ELECTRIC POWER SOURCE CONTROL DEVICE, CONTROL METHOD, AND STORAGE MEDIUM

(71) Applicant: TOYOTA JIDOSHA KABUSHIKI KAISHA, Toyota-shi (JP)

(72) Inventor: Takuya ITOH, Toyota-shi (JP)

(73) Assignee: TOYOTA JIDOSHA KABUSHIKI KAISHA, Toyota-shi (JP)

(21) Appl. No.: 18/299,805

(22) Filed: Apr. 13, 2023

(30) Foreign Application Priority Data
Jun. 28, 2022 (JP) 2022-103896

(51) Int. Cl. H02J 7/00; H02J 7/34

(52) U.S. Cl. CPC H02J 7/00714; H02J 7/0036; H02J 7/0047; H02J 7/342; H02J 2207/20

(57) ABSTRACT

An electric power source control device includes an acquisition unit that acquires a charging/discharging current of a low-voltage battery, a detection unit that detects a predetermined operation executed with respect to a high-voltage battery, and a determining unit that determines presence/absence of an abnormality with respect to a connection state of the low-voltage battery, based on the charging/discharging current. When the predetermined operation is detected, the determining unit determines whether a state in which the charging/discharging current is no greater than a first threshold value continues for a first duration of time, controls an electric power converter when the state continues for the first duration of time, and further determines whether the state continues for a second duration of time longer than the first duration of time, and determines that the connection state of the low-voltage battery is abnormal when the state continues for the second duration of time.

### CROSS-REFERENCE TO RELATED APPLICATION

This application claims priority to Japanese Patent Application No. 2022-103896 filed on Jun. 28, 2022, incorporated herein by reference in its entirety.

### BACKGROUND

### 1. Technical Field

The present disclosure relates to an electric power source control device that controls an electric power converter that connects a high-voltage battery and a low-voltage battery, and so forth.

### 2. Description of Related Art

Japanese Patent No. 4941461 (JP 4941461 B) discloses an in-vehicle charging device that performs charging control of a low-voltage battery, by operating a step-down converter that steps down voltage of a high-voltage battery and applies the voltage to the low-voltage battery. This in-vehicle charging device detects wire disconnection occurring between the step-down converter and the low-voltage battery, based on a voltage difference between output voltage of the step-down converter and voltage of the low-voltage battery.

### SUMMARY

In a state of a connection abnormality, in which the low-voltage battery is not connected to the step-down converter in a normal state, due to wire disconnection, terminal disconnection, or the like, the low-voltage battery cannot be charged/discharged. Accordingly, it is conceivable to detect charging/discharging current of the low-voltage battery and determine whether a connection abnormality is occurring at the low-voltage battery.

However, there are situations in which electric power of the high-voltage battery is controlled while the low-voltage battery installed in a vehicle is intentionally placed in a state in which charging/discharging of the low-voltage battery is not performed, such as while the vehicle is parked, for example. Accordingly, simply detecting the presence or absence of a charging/discharging current at the low-voltage battery may lead to erroneous determination that connection abnormality is occurring.

The present disclosure has been made in view of the above issues, and it is an object of the present disclosure to provide an electric power source control device and so forth that can suppress erroneous determination of a connection abnormality of a low-voltage battery, in a technique for detecting charging/discharging current of the low-voltage battery.

In order to solve the above issues, one aspect of the technology according to the present disclosure is an electric power source control device that controls an electric power converter that connects a high-voltage battery and a low-voltage battery. The electric power source control device includes an acquisition unit that acquires a charging and discharging current of the low-voltage battery, a detection unit that detects a predetermined operation executed with respect to the high-voltage battery, and a determining unit that determines presence or absence of an abnormality with respect to a connection state of the low-voltage battery, based on the charging and discharging current. When the predetermined operation is detected, the determining unit determines whether a state in which the charging and discharging current is no greater than a first threshold value continues for a first duration of time, controls the electric power converter when the state in which the charging and discharging current is no greater than the first threshold value continues for the first duration of time, and further determines whether the state in which the charging and discharging current is no greater than the first threshold value continues for a second duration of time that is longer than the first duration of time, and determines that the connection state of the low-voltage battery is abnormal when the state in which the charging and discharging current is no greater than the first threshold value continues for the second duration of time.

According to the electric power source control device and the like of the present disclosure, in a technique of detecting the charging/discharging current of the low-voltage battery, erroneous determination of connection abnormality of the low-voltage battery can be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a functional block diagram of an electric power source control device according to an embodiment of the present disclosure, and components in a vicinity thereof;

FIG. 2 is a processing flowchart of connection state determination control executed by the electric power source control device;

FIG. 3 is a timing chart showing when a connection state of a low-voltage battery is normal; and

FIG. 4 is a timing chart showing when the connection state of the low-voltage battery is abnormal.

### DETAILED DESCRIPTION OF EMBODIMENTS

An electric power source control device according to the present disclosure performs stepwise determination of a duration of time, in which a state of a charging/discharging current of a low-voltage battery continues to be no greater than a predetermined threshold value, while controlling change in the charging/discharging current. Thus, whether a connection state of the low-voltage battery is normal or abnormal can be judged with good precision, simply by detecting the charging/discharging current of the low-voltage battery. An embodiment of the present disclosure will be described in detail below with reference to the drawings.

### Embodiment

### Configuration

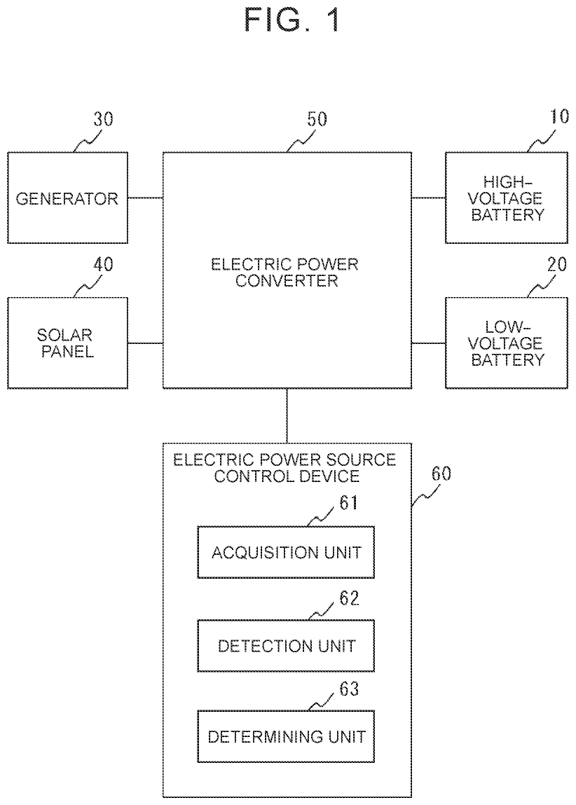

FIG. 1 is a functional block diagram of an electric power source control

device 60 according to an embodiment of the present disclosure, and components in a vicinity thereof. The functional blocks exemplified in FIG. 1 include a high-voltage battery 10, a low-voltage battery 20, a generator 30, a solar panel 40, an electric power converter 50, and the electric power source control device 60. The high-voltage battery 10, the low-voltage battery 20, the generator 30, the solar panel 40, the electric power converter 50, and the electric power source control device 60 can be installed in a vehicle or the like.

The high-voltage battery 10 is a secondary battery that is configured to be capable of charging/discharging, such as for example, a lithium-ion battery, a nickel-metal hydride battery, or the like. The high-voltage battery 10 is connected to the electric power converter 50 so as to be charged with electric power generated by the generator 30 and the solar panel 40. The high-voltage battery 10 is also connected to the electric power converter so as to enable electric power output (feed control) to a low-voltage load (omitted from illustration) that is exclusively driven by electric power of the low-voltage battery 20. Examples of the high-voltage battery 10 installed in the vehicle include a so-called traction battery that is capable of supplying electric power necessary to operate high-voltage loads (omitted from illustration), such as a starter motor, an electric motor, and so forth.

The low-voltage battery 20 is a secondary battery such as, for example, a lithium-ion battery, a lead-acid battery, or the like, which is configured so as to be capable of charging/discharging. The low-voltage battery 20 is connected to the electric power converter 50 so as to be capable of being charged with electric power generated by the generator 30 and the solar panel 40. Also, the low-voltage battery 20 is connected to the electric power converter 50 so as to be capable of charging the high-voltage battery 10. The low-voltage battery 20 installed in the vehicle is a so-called auxiliary battery that can supply electric power necessary for operating low-voltage loads, examples of which include lights such as headlamps, interior lights, and so forth, and air conditioning devices such as heaters, coolers, and so forth.

The generator 30 is a device such as, for example, an alternator that is capable of generating predetermined electric power, and is connected to the electric power converter 50 so as to be capable of outputting the generated electric power. The electric power output by the generator 30 is controlled by the electric power converter 50.

The solar panel 40 is, for example, equipment such as a solar cell module that can receive sunlight and generate predetermined electric power, and is connected to the electric power converter 50 so as to be capable of outputting the generated electric power. This solar panel 40 can be mounted on a roof or the like of a vehicle, for example. The electric power output by the solar panel 40 is controlled by the electric power converter 50.

The electric power converter 50 is a device that is capable of inputting electric power generated by the generator 30 and the solar panel 40, converting this electric power to a predetermined voltage (stepping up/down), and performing output thereof to the high-voltage battery 10 and the low-voltage battery 20. Also, the electric power converter 50 is capable of inputting electric power stored in the high-voltage battery 10, stepping it down to a predetermined voltage, and performing output thereof to the low-voltage battery 20. This electric power converter 50 has a configuration including a direct current (DC)-to-DC converter and the like.

The electric power source control device 60 is configured to control the electric power converter 50 so as to control electric power transfer among the high-voltage battery 10, the low-voltage battery 20, the generator 30, and the solar panel 40. In particular, the electric power source control device 60 according to the present embodiment performs control for determining presence or absence of an abnormality in a connection state of the low-voltage battery 20. In order to perform this determination control, the electric power source control device 60 includes an acquisition unit 61, a detection unit 62, and a determining unit 63.

The acquisition unit 61 acquires charging/discharging current, which is charging current flowing into the low-voltage battery 20 and discharging current flowing out from the low-voltage battery 20. A current sensor or the like included in the electric power converter 50 or the low-voltage battery 20 can be used to acquire the charging/discharging current.

The detection unit 62 detects a predetermined operation executed with respect to the high-voltage battery 10. The predetermined operation is a control operation for changing the electric power of the high-voltage battery 10 while maintaining a State of Charge (SOC) of the low-voltage battery 20, i.e., keeping the low-voltage battery 20 in a state of being neither charged nor discharged (charging/discharging current=0). Examples of this predetermined operation include control for supplying electric power from the high-voltage battery 10 to a low-voltage system load connected to the low-voltage battery 20 via the electric power converter 50 (feed control), control for charging the high-voltage battery with electric power generated by the solar panel 40, via the electric power converter 50 (solar high-voltage charging control), and so forth.

The feed control is control to activate a high-voltage system including the high-voltage battery 10, and supply electric power from the high-voltage battery 10 to equipment requiring the electric power when entering the vehicle before changing a vehicle state to a READY-ON state, and when exiting the vehicle after the vehicle state is changed to a READY-OFF state, thereby suppressing deterioration of the low-voltage battery 20. The purpose of this feed control is to supply electric power to equipment that operates when entering and exiting the vehicle, while suppressing consumption of the high-voltage battery and accordingly the DC-to-DC converter is controlled to a voltage such that the low-voltage battery 20 is neither charged nor discharged.

Also, solar high-voltage charging control is control of which the purpose is to charge the high-voltage battery 10 with electric power generated by the solar panel 40, so as to extend traveling distance. The solar high-voltage charging control is automatically activated when the solar panel 40 receives sunlight after ignition of the vehicle is turned off (IG-OFF), following which charging of the high-voltage battery 10 is started. Charging of the high-voltage battery 10 is prioritized in the solar high-voltage charging control, and accordingly electric power that neither charges nor discharges the low-voltage battery 20 is required of the solar panel 40 by feedback control.

When the detection unit 62 detects the predetermined operation, the determining unit 63 changes the output voltage of the electric power converter 50 as appropriate, based on the charging/discharging current acquired by the acquisition unit 61, thereby determining presence or absence of an abnormality with respect to the connection state of the low-voltage battery 20. Examples of abnormalities related to the connection state of the low-voltage battery 20 include a state in which a terminal of the low-voltage battery has become disconnected, a state in which there is wire disconnection in wiring connecting the low-voltage battery 20 to the electric power converter 50, and so forth. Details of the control performed by the determining unit 63 will be described later.

Part or all of the above-described electric power source control device 60 may typically be configured as an electronic control unit (ECU) including a processor, memory, an input/output interface, and so forth. The electronic control unit is capable of realizing part or all of the acquisition unit 61, the detection unit 62, and the determining unit 63, by the processor reading and executing programs stored in the memory.

### Control

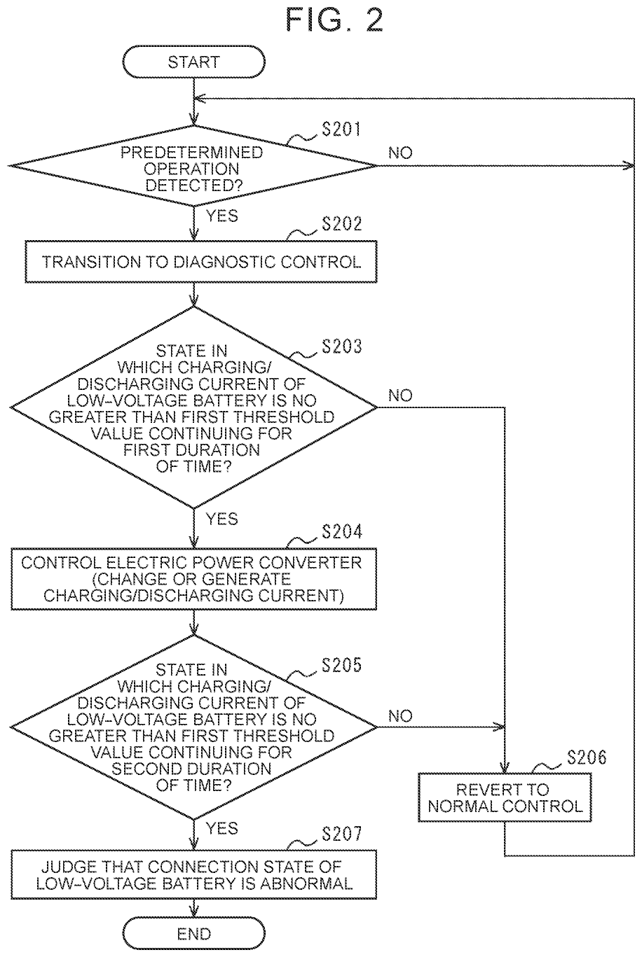

Next, the control executed by the electric power source control device 60 will be described, with further reference to FIG. 2. FIG. 2 is a flowchart showing processing procedures of connection state determination control executed by the components of the electric power source control device 60.

The connection state determination control exemplified in FIG. 2 is started when the ignition of the vehicle is turned off (IG-OFF) while the vehicle is parked, stopped, or the like, and is repeatedly executed until the ignition is turned on (IG-ON) the next time, when no determination is made that there is an abnormality.

### Step S201

The detection unit 62 judges whether the predetermined operation that is executed with respect to the high-voltage battery 10 has been detected. More specifically, the detection unit 62 judges whether the operation of intentionally controlling the charging/discharging current of low-voltage battery 20 to zero, and operating the high-voltage system including the high-voltage battery 10, has started. When the detection unit 62 judges that the predetermined operation has been detected (YES in step S201), the processing advances to step S202.

### Step S202

The electric power source control device 60 transitions a state of “normal control” for controlling electric power transfer among the high-voltage battery 10, the low-voltage battery 20, the generator 30, and the solar panel 40, to a state of “diagnostic control” for determining the connection state of the low-voltage battery 20. When the state transitions to the diagnostic control, the processing advances to step S203.

### Step S203

The determining unit 63 judges whether a state in which the charging/discharging current of the low-voltage battery 20 is no greater than a first threshold value has continued for a first duration of time. This judgement is performed to tentatively determine whether the low-voltage battery 20 is in a state of neither charging nor discharging.

The first threshold value is typically zero. The first duration of time can be set based on determination precision, detection capabilities, or the like, and can be set to one second, for example. When the determining unit 63 judges that the charging/discharging current of the low-voltage battery 20 has continued to be no greater than the first threshold value for the first duration of time (YES in S203), the processing advances to step S204. On the other hand, when the determining unit 63 judges that the charging/discharging current of the low-voltage battery 20 has not continued to be no greater than the first threshold value for the first duration of time (NO in S203), the processing advances to step S206.

### Step S204

The determining unit 63 controls the electric power converter 50 to forcibly change or generate the charging/discharging current of the low-voltage battery 20. The current that is changed or generated may be either in the charging direction or in the discharging direction. As an example, when the predetermined operation detected in the above-described step S201 is feed control, it is conceivable to raise or lower the voltage instructed regarding the DC-to-DC converter that steps down and outputs the electric power of the high-voltage battery 10. Also, when the predetermined operation detected in the above-described step S201 is solar high-voltage charging control, it is conceivable to reduce the electric power regarding which the solar panel 40 is requested to generate. Upon the electric power converter 50 being controlled by the determining unit 63, the processing advances to step S205.

### Step S205

After controlling the electric power converter 50, the determining unit 63 judges whether the state in which the charging/discharging current of the low-voltage battery 20 is no greater than the first threshold value has further continued for the second duration of time. This judgement is performed to make final determination whether the low-voltage battery 20 is in a state of neither charging nor discharging. The second duration of time is set to be longer than the first duration of time, and can be, for example, three seconds. When the determining unit 63 judges that the charging/discharging current of the low-voltage battery 20 has continued to be no greater than the first threshold value for the second duration of time (YES in S205), the processing advances to step S207. On the other hand, when the determining unit 63 judges that the charging/discharging current of the low-voltage battery has not continued to be no greater than the first threshold value for the second duration of time (NO in S205), the processing advances to step S206.

### Step S206

The electric power source control device 60 reverts to the state of “normal control” for controlling electric power transfer among the high-voltage battery 10, the low-voltage battery 20, the generator 30, and the solar panel 40, from the state of “diagnostic control” for determining the connection state of the low-voltage battery 20. Upon the state reverting to normal control, the processing advances to step S201.

### Step S207

The determining unit 63 judges (confirms) that there is an abnormality in the connection state of the low-voltage battery 20. The determining unit 63 may stop operation of the electric power converter 50 when judging that there is an abnormality. This stopping of operation further ensures safety during service work and the like. When the determining unit 63 judges that the connection state of the low-voltage battery 20 is abnormal, the connection state determination control ends.

### Example of Timing of Operation

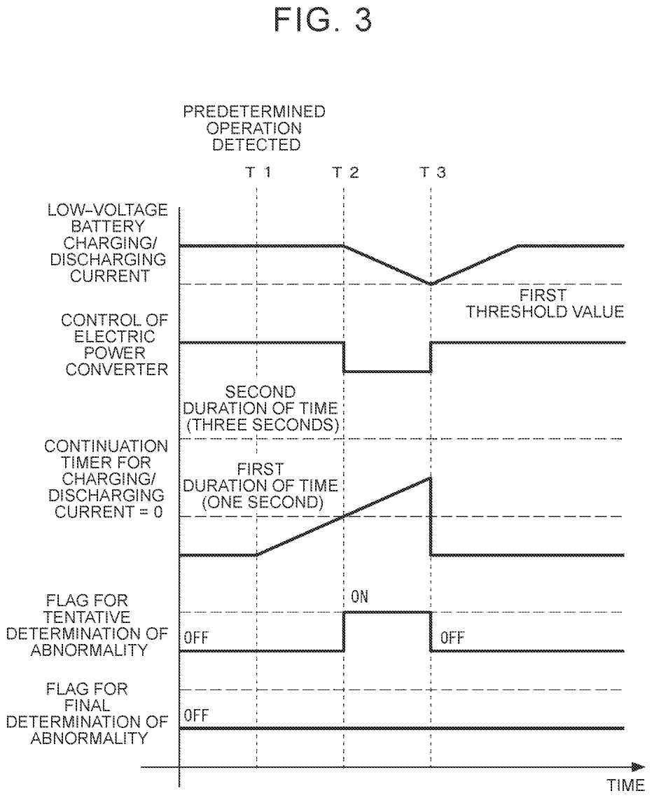

FIG. 3 shows an example of a timing chart of each state when the connection state of the low-voltage battery 20 is normal.

At time T1, execution of the predetermined operation with respect to the high-voltage battery 10 is detected. When the predetermined operation is detected, a timer or the like is used to start measuring the duration of time during which the state in which the charging/discharging current of the low-voltage battery 20 is zero continues. Thereafter, at time T2, when the state in which the charging/discharging current of the low-voltage battery 20 is zero continues for the first duration of time (for example, one second), a flag for tentative abnormality determination is set to on, and the electric power converter 50 performs control to cause charging/discharging current of the low-voltage battery 20 to change. For example, when the predetermined operation is feed control, voltage instructed regarding the DC-to-DC converter that steps down and outputs the electric power of the high-voltage battery 10 is lowered by 0.5 V, and when the predetermined operation is solar high-voltage charging control, the electric power that the solar panel 40 is requested to generate is lowered by 5 W. When the connection state of the low-voltage battery 20 is normal as shown in FIG. 3, the charge/discharge current of the low-voltage battery 20 decreases in accordance with the control of the electric power converter 50, to a level that is no greater than the first threshold value, at time T3. Accordingly, at this timing, the flag for tentative determination of abnormality is turned off, and confirmation is made that the connection state of the low-voltage battery 20 is normal.

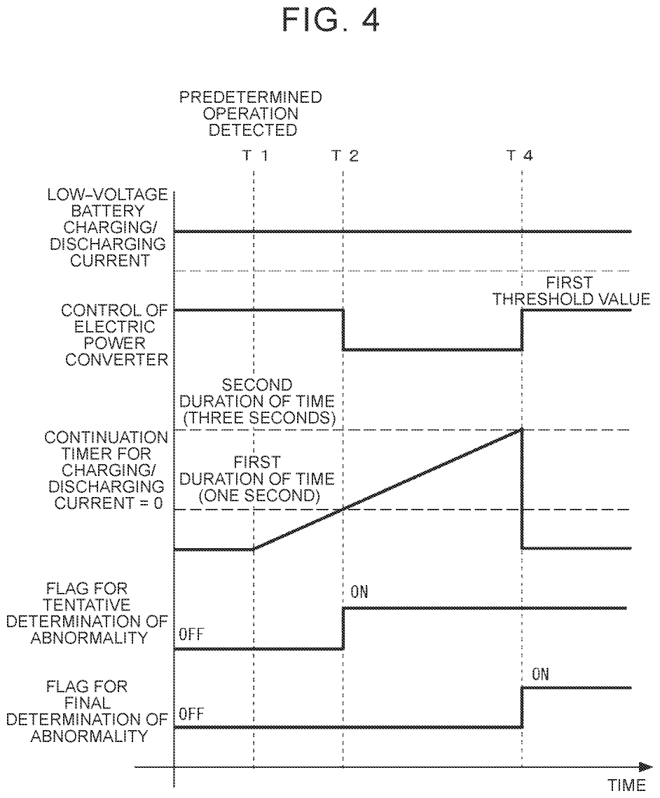

FIG. 4 shows an example of a timing chart of each state when the connection state of the low-voltage battery 20 is abnormal.

At time T1, execution of the predetermined operation with respect to the high-voltage battery 10 is detected. When the predetermined operation is detected, a timer or the like is used to start measuring the duration of time during which the state in which the charging/discharging current of the low-voltage battery 20 is zero continues. Thereafter, at time T2, when the state in which the charging/discharging current of the low-voltage battery is zero continues for the first duration of time (for example, one second), a flag for tentative abnormality determination is set to on, and the electric power converter 50 performs control to cause charging/discharging current of the low-voltage battery 20 to change. When the connection state of the low-voltage battery 20 is abnormal as shown in FIG. 4, the charging/discharging current of the low-voltage battery 20 does not decrease in response to control by the electric power converter 50 and does not reach a level no greater than the first threshold value, and accordingly the state in which the charging/discharging current of the low-voltage battery 20 is zero at time T4 continues for the second duration of time (for example, 3 seconds). Accordingly, at this timing, a flag for final determination of abnormality is set to on, and confirmation is made that the connection state of the low-voltage battery 20 is abnormal.

### Operations and Effects

As described above, in the electric power source control device 60 according to the embodiment of the present disclosure, in the technique of judging connection abnormality of the low-voltage battery 20 based on the charging/discharging current of the low-voltage battery 20, upon execution of the predetermined operation with regard to the high-voltage battery 10 being detected, first, whether the state in which the charging/discharging current is no greater than the first threshold value continues for the first duration of time is determined (tentative determination). When the state in which the charging/discharging current is no greater than the first threshold value continues for the first duration of time here, the electric power converter 50 is then controlled, and determination is further performed regarding whether the state in which the charging/discharging current is no greater than the first threshold value continues for a second duration of time, which is longer than the first duration of time (final determination). When the state in which the charging/discharging current is no greater than the first threshold value continues for the second duration of time, confirmation is made that the connection state of the low-voltage battery 20 is abnormal.

By determining the connection state of the low-voltage battery 20 through such stepwise determination, erroneous determination of connection abnormality of the low-voltage battery 20 can be suppressed simply by detecting the charging/discharging current of the low-voltage battery 20, even in a situation in which the electric power of the high-voltage battery 10 is controlled in a state in which the low-voltage battery 20 is intentionally not charged or discharged, such as while the vehicle is parked, for example. Also, when the low-voltage battery 20 is in a fully charged state, detection of the charging/discharging current is difficult, and accordingly controlling the electric power converter 50 to the discharging side enables erroneous determination of connection abnormality of the low-voltage battery 20 to be suppressed.

Even in a situation in which a worker attempts to start the high-voltage system without noticing that a connection terminal of the low-voltage battery 20 is disconnected during service work, such as vehicle maintenance for example, the connection state of the low-voltage battery 20 is judged to be abnormal and operation of the electric power converter 50 is stopped, due to appropriately judging connection abnormality of the low-voltage battery 20 by the control of the present embodiment. Accordingly, safety and security of workers during service work can be ensured.

Although an embodiment of the technology according to the present disclosure has been described above, the present disclosure can be understood as being, in addition to the electric power source control device, a method executed by the electric power source control device, a program of the method, a computer-readable non-transitory storage medium storing the program, a vehicle in which the electric power source control device is installed, and so forth.

The electric power source control device and so forth according to the present disclosure can be used in vehicles and the like equipped with a high-voltage battery and a low-voltage battery.

What is claimed is:

1. An electric power source control device that controls an electric power converter that connects a high-voltage battery and a low-voltage battery, the electric power source control device comprising:
an acquisition unit that acquires a charging and discharging current of the low-voltage battery;
a detection unit that detects a predetermined operation executed with respect to the high-voltage battery; and
a determining unit that determines presence or absence of an abnormality with respect to a connection state of the low-voltage battery, based on the charging and discharging current, wherein, when the predetermined operation is detected, the determining unit
determines whether a state in which the charging and discharging current is no greater than a first threshold value continues for a first duration of time, controls the electric power converter when the state in which the charging and discharging current is no greater than the first threshold value continues for the first duration of time, and further determines whether the state in which the charging and discharging current is no greater than the first threshold value continues for a second duration of time that is longer than the first duration of time, and
determines that the connection state of the low-voltage battery is abnormal when the state in which the charging and discharging current is no greater than the first threshold value continues for the second duration of time.

2. The electric power source control device according to claim 1, wherein:
the predetermined operation is an operation of supplying electric power from the high-voltage battery to a load connected to the low-voltage battery via the electric power converter; and
the determining unit controls the electric power converter to change output voltage of the electric power converter when the state in which the charging and discharging current is no greater than the first threshold value continues for the first duration of time.

3. The electric power source control device according to claim 1, wherein:
the predetermined operation is an operation of charging the high-voltage battery with electric power generated by a solar panel via the electric power converter; and
the determining unit controls the electric power converter to change the electric power that the electric power converter inputs from the solar panel when the state in which the charging and discharging current is no greater than the first threshold value continues for the first duration of time.

4. The electric power source control device according to claim 1, wherein the abnormal connection state of the low-voltage battery includes a state in which a terminal of the low-voltage battery is disconnected, and a state in which wiring connecting the low-voltage battery to the electric power converter is disconnected.

5. The electric power source control device according to claim 4, wherein, when determining that the connection state of the low-voltage battery is abnormal, the determining unit stops operation of the electric power converter.

6. A control method executed by an electric power source control device that controls an electric power converter that connects a high-voltage battery and a low-voltage battery, the control method comprising:
detecting a predetermined operation executed with respect to the high-voltage battery;
acquiring a charging and discharging current of the low-voltage battery when the predetermined operation is detected, and determining whether a state in which the charging and discharging current is no greater than a first threshold value continues for a first duration of time;
controlling the electric power converter when the state in which the charging and discharging current is no greater than the first threshold value continues for the first duration of time, and further determining whether the state in which the charging and discharging current is no greater than the first threshold value continues for a second duration of time that is longer than the first duration of time; and
determining that a connection state of the low-voltage battery is abnormal when the state in which the charging and discharging current is no greater than the first threshold value continues for the second duration of time.

7. A non-transitory storage medium storing a control program that is executed by a computer of an electric power source control device that controls an electric power converter that connects a high-voltage battery and a low-voltage battery, the control program comprising:
detecting a predetermined operation executed with respect to the high-voltage battery;
acquiring a charging and discharging current of the low-voltage battery when the predetermined operation is detected, and determining whether a state in which the charging and discharging current is no greater than a first threshold value continues for a first duration of time;
controlling the electric power converter when the state in which the charging and discharging current is no greater than the first threshold value continues for the first duration of time, and further determining whether the state in which the charging and discharging current is no greater than the first threshold value continues for a second duration of time that is longer than the first duration of time; and
determining that a connection state of the low-voltage battery is abnormal when the state in which the charging and discharging current is no greater than the first threshold value continues for the second duration of time.
